(19) United States
(12) Patent Application Publication
(10) Pub. No.: US 2006/0198606 A1
(43) Pub. Date: Sep. 7, 2006

(54) METHOD AND APPARATUS FOR COPYING DIGITAL VIDEO TAPE

(76) Inventor: Hsin Liu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/306,198

(22) Filed: Dec. 19, 2005

(30) Foreign Application Priority Data
Dec. 27, 2004 (TW) 093140932

(51) Int. Cl. H04N 5/91

(52) U.S. Cl. 386/94

(57) ABSTRACT

A method and apparatus for copying a digital video tape provide options of a copy mode, a play mode, and a record mode. The apparatus includes a playback device having a room to accommodate the digital video tape. A control unit controls the playback device to drive and read video data on the digital video tape. The video data are formatted by an encoder/decoder unit. The control unit controls a disk device to spindle a disc to record the formatted video data on the disc. The playback device and the disk device can be integrated in one apparatus to simplify the copy procedure.

### BACKGROUND OF THE INVENTION

1. Field of the Invention

The present invention relates to a method for copying a digital video tape, and more particularly to a method and apparatus for quickly recording video data of the digital video tape, provided by a camcorder, on a disc.

2. Description of the Prior Art

Since the digital technology promptly develops, digital signal is to substitute analog signals in a camcorder. The current information storage medium of a camcorder mainly includes a digital video tape, a flash memory card, and a recordable DVD disc, wherein the flash memory card has smaller memory capacity not enough to record data for a long time, and the recordable DVD disc is a bigger size and easy to cause damage. Therefore, the digital video tape becomes the main stream of camcorders because of portable feature and long-time record.

However, the video data recorded on the digital video tape is hard to rapidly access, can't be saved for a long time, and is not easy to be freely edited. If it needs to be edited on a computer or to share with remote friends, the video data must be copied on a DVD disc. Referring to FIG. 1, a conventional camcorder 1 utilizes a wire 2 to connect the IEEE1394 ports of the conventional camcorder 1 and the host 4 of the computer 3. Then, A DVD disc 5 is inserted into the disk drive 6 of the host 4. The camcorder 1 reads the video data on the digital video tape and transmits video data to the host 4 through the wire 2 between the IEEE1394 output ports of the conventional camcorder 1 and the IEEE1394 input ports of the host 4. By means of the copying operation of the computer 3, video data are changed into the record format of DVD disc, such as MPEG format, to display on the screen of the computer 3, and are recorded on the DVD disc 5 of the disk drive 6 to save for a longer time. Due to non-friendly software, it is so complicated for an ordinary user to finish the copying operation of the computer 3, and bring users a real embarrassment.

Although, there are DVD recorders with the digital or analog specifications on the current market, which users can choose the digital or analog connection between the camcorder and the DVD recorder to transmit signals, users are confused by various kinds of connection option and wires on the contrary. For example, users must firstly connect the corresponding ports with the right wire correctly to finish digital or analog connections, turn the digital video tape back to the start, and set the record mode. Finally, playback the digital video tape and push down the record button of the DVD recorder at the same time to copy video data. Therefore, it is not easy and simple to finish the copying operation. The camcorder still has some problems to be solved.

### SUMMARY OF THE INVENTION

It is one object of the invention to provide an apparatus for copying a digital video tape, which integrates a playback device of the digital video tape and a recordable disk device to easily and rapidly copy video data.

It is another object of the invention to provide a method for copying a digital video tape, which sets the procedure to automatically copy the digital video tape for simplifying the copy operation.

It is further object of the invention to provide a method for copying a digital video tape, which has the options of several operation modes and the multi-function purpose to expand adoptable scopes.

For achieving the above objects, the present invention provides an apparatus for copying a digital video tape, which includes a playback device having a room to accommodate the digital video tape. A control unit drives and reads video data of the digital video tape to be converted into a proper format by an encoder/decoder unit. Meanwhile, the control unit controls a disk device spindling a disc to record or read video data on the disc. The playback device of the digital video tape and the disk device can be integrated in one apparatus.

The present invention also provides a method of copying a digital video tape, which comprises the step of inserting a storage medium into the playback device or the disk device, selecting the operation of copy mode, play mode, or recording mode, detecting the position and memory capacity of the storage medium, and starting to playback, read, and record video data on the storage medium. The operation of copying the digital video tape can be simplified.

Further features and advantages of the invention, as well as the structure and operation of various embodiments of the invention, are described in detail below with reference to the accompanying drawings.

### BRIEF DESCRIPTION OF THE DRAWINGS

FIG. 1 is a schematic view showing the connection of a conventional copying the digital video tape.

FIG. 2 is a block diagram showing the apparatus for copying the video tape according to the present invention.

FIG. 3 is a flow chart showing the apparatus for copying the video tape according to the present invention.

### DETAILED DESCRIPTION

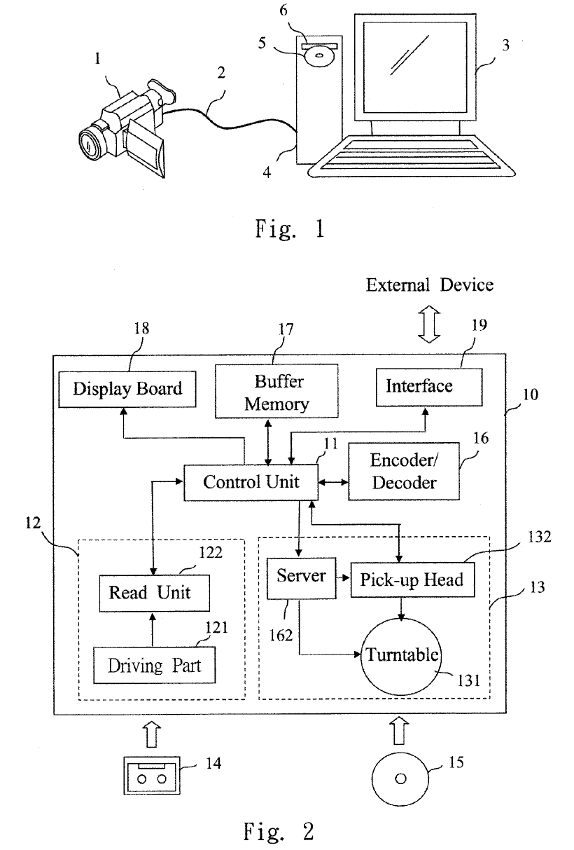

Referring to FIG. 2, a copying apparatus 10 of the present invention includes a control unit 11, a playback device 12, and a disk device 13. The control unit 11 controls the playback device 12 to read video data of a digital video tape 14, formats the video data, transmits video data to the disk device 13, and controls the disk device 13 to recording the video data on a disc 15. Thus, the video data of the digital video tape 14 can be copied to the disc 15.

The playback device 12, mainly driving the digital video tape 14 to read video data on it, includes a driving part 121 and a read unit 122. The driving part 121 has a room to accommodate the cassette-type digital video tape 14 which can be inserted into or removed from the room. The driving part 121 can spindle the digital video tape 14, and the read unit 122 sequentially reads video data on the rotating digital video tape 14.

The disk device 13, which basically is a recordable optical disk drive, includes a turntable 131, a pick-up head 132, and a server 133. The turntable 131 carries the disc 15 to be removed from the copying apparatus 10 for exchanging the disc 15, or to be inserted into the copying apparatus 10 for playbacking and spindling the disc 15. The pick-up head 132, which can be an optical pick-up head, radiates a light beam, such as a laser beam or an electronic beam, onto the disc 15. The server 133 controls the pick-up head 132 to move along the redial direction of the disc 15 to search addresses of video data which need to be read or recorded on the disc 15, and controls the focusing serve, tracking serve, and the velocity of reading and recording video data.

Besides, the copying apparatus 10 further includes an encoder/decoder unit 16 which converts video data into the format file such as MPEG capable of being recorded by the disk device 13. Since the velocity of reading, recording, and transmitting video data of the playback device 12 is different from that of the disk device 13, they can not properly match each other to cause video data losing during the copying procedure. To prevent video data from losing, the copying apparatus 10 also includes a buffer memory 17 to store the delivering video data for harmonizing the data velocity of the playback device 12 and the disk device 13. The copying apparatus 10 utilizes the control unit 11, such as a microprocessor, to control the operation among the playback device 12, the disk device 13, the encoder/decoder unit 16, and the buffer 17. The copying apparatus 10 also provides options of operating modes including a copy mode, a play mode, or a recording mode, wherein the copy mode operates the playback device 12 and the disk device 13 to copy video data on the digital video tape 14 to the disc 15, the play mode only operates the playback device 12 to playback the digital video tape 14 or the disk device 13 to read data on the disc 15, and the recording mode only operates the disk device 13 to record data on the disc 15. Furthermore, the copying apparatus 10 has a display board 18 to show the operation situation of the playback device 12, the disk device 13, and the control unit 11, such as copy, play, forward, backward, record time, and error message. The copying apparatus 10 further includes interfaces 19 to externally connect other devices, such as a computer or a LCD monitor.

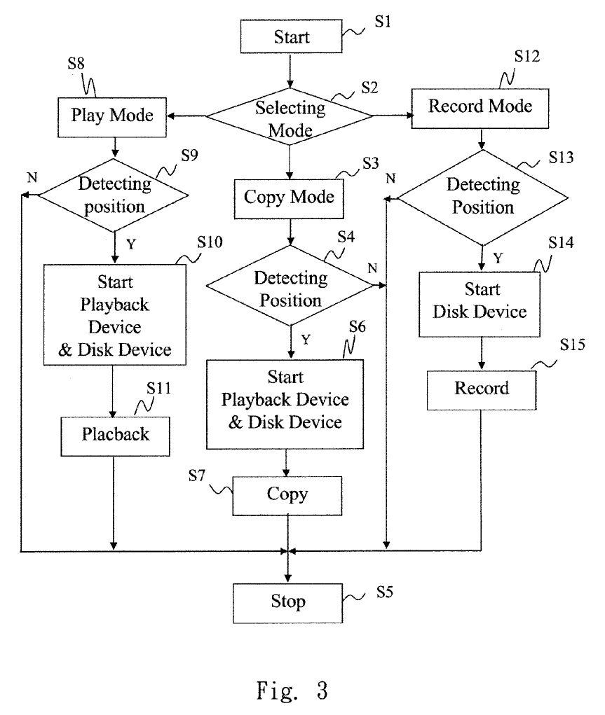

As shown in FIG. 3, a method for copying the digital video tape includes steps as follow. In start step S1, the storage mediums firstly are inserted into the copy apparatus 10. That is, the digital video tape 14 is inserted in the playback device 12, and/or the disc 15 is putted on the turntable 131 and carried to the play position of the disk device 13. The step S2 is to selecting operation molds. When selecting the copy mode in step S3, the control unit 111 detects the position and memory capacity of the digital video tape 14 and the disc 15 in step S4. If the position is not correct or the memory capacity does not match, the copy mode will go to the stop step S5. Otherwise the copy mode will start to operate the playback device 12 and the disk device 13 at the same time in step S6. In step S7, the control unit 111 controls the driving part 121 to spindle the digital video tape 14, the read unit 122 to read out video data on the rotating digital video tape 14, and the buffer memory 17 to temporarily store the video data. Then, the encoder/decoder unit 16 converts the video data read out from the buffer memory 17 into a format capable of recording video data on the disc 15, and the video data can also be transmitted to external devices to display image through the interface 19 for option. The disk device 13 receives formatted video data, and the server 133 controls the pick-up head 132 to record video data on the disc 15. After finishing the copy mode, the display board 18 shows the completion and goes to the stop step S5.

When selecting the play mold of step S8, in step S9, the control unit 11 first detects if the digital video tape 14 or the disc 15 is positioned. If not, go to the stop step S5. Otherwise one of the playback device 12 and the disk device 13 starts in step S10 based on the detection. In step S11, the video data on the digital video tape 14 or the disc 15 be read out to temporarily store on the buffer memory 17, and the control unit 11 controls the encoder/decoder unit 16 to convert the video data from the buffer memory 17 into a format capable of being transmitted to external devices through the interface 19 for displaying image. When selecting the record mode of step S12, the control unit 11 detects if the disc 15 is positioned in step 13. If not, go to the stop step S5. Otherwise the control unit 11 starts the disk device 13 in step S14. In step S15, the control unit 111 receives data from an external device connecting to the interface 19, and controls the disk device 13 to record the data on the disc 15.

Therefore, the playback device 12 and the disk device 13 are integrated into the copy apparatus 10. By selecting the copy mode, the play mode, or the record mole, the copy apparatus 10 provides functions of the playback device of the digital video tape, the player, and the recordable disk drive. By means of the automatic copy procedure, users only push the button of the copy apparatus 10 to copy video data of the digital video tape on discs. Thus, the operation of copying the digital video tape is simplified.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for copying the digital video tape, which is used for an copy apparatus integrating a playback device and a disk device, comprising steps of:
(1) inserting storage mediums in the apparatus;
(2) selecting one of operating modes of the apparatus;
(3) detecting the storage mediums based on the selected operating mode, and going to a stop step if it does not match; and
(4) if the operating mode is a copy mode, starting the playback device to read video data on one storage medium and starting the disk device to record the video data on the other storage medium.

2. The method of claim 1, wherein, in step (1), the storage medium in the playback device is a digital video tape and the storage medium in the disk device is an optical disc.

3. The method of claim 1, wherein the copy apparatus, in step (3), detects the position and the memory capacity of the storage mediums in the playback device and the disk device, and goes to a stop step if the position is not correct or the memory capacity does not match each other.

4. The method of claim 1, wherein the video data read by the playback device are formatted in step (4) before the disk device records on the storage medium.

5. The method of claim 4, wherein the video data read by the playback device are temporarily stored in a buffer memory after being formatted.

6. The method of claim 1, wherein the operating modes further include a play mode and a record mode.

7. The method of claim 6, wherein if selecting the record mode in step (2), the method comprises steps of:
(5) detecting the position of the storage mediums of the disk device, and going to a stop step if the position of the storage mediums is not correct; and
(6) starting the disk device to record the storage medium.

8. The method of claim 7, wherein the copy apparatus further comprises an interface capable of connecting with an external device which provides data to be recorded on the storage medium.

9. The method of claim 6, wherein if selecting the play mode in step (2), method comprises steps of:
(7) detecting the position of the storage mediums of the playback device and the disk device, and goes to a stop step if the position is not correct; and
(8) starting one of the playback device and the disk device to playback the storage medium based on the one having the storage medium is detected.

10. A copy apparatus, comprising:
a control unit which is microprocessor;
a playback device having a room to accommodate a digital video tape, which is controlled by the control unit to drive and read video data on the digital video tape, and transmits the video data to the control unit;
a disk drive carrying a disc, which is controlled by the control unit to rotate, record, and read video data on the disc; and
an encoder/decoder formatting the video data.

11. The copy apparatus of claim 10, wherein the copy apparatus further comprises a buffer memory to temporarily store the video data read from the playback device.

12. The copy apparatus of claim 10, wherein the copy apparatus further comprises a display board which displays operating situations of the control unit, the playback device, and the disk device.

13. The copy apparatus of claim 10, wherein the copy apparatus further comprises an interface capable of connecting external devices to input/output video data.
